(19) United States
(12) Patent Application Publication
(10) Pub. No.: US 2009/0315809 A1
(43) Pub. Date: Dec. 24, 2009

(54) DISPLAY DEVICE

(75) Inventors: Yoshio SHIBUKAWA, Kobe-shi (JP); Tetsuya Makino, Kobe-shi (JP); Takamitsu Bunno, Kobe-shi (JP); Koji Shinohe, Kobe-shi (JP); Hitoshi Hirakawa, Kobe-shi (JP); Kenji Awamoto, Kobe-shi (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CO., LTD., Kobe-shi (JP)

(21) Appl. No.: 12/485,560

(22) Filed: Jun. 16, 2009

(30) Foreign Application Priority Data
Jun. 18, 2008 (JP) 2008-159763

(51) Int. Cl. G09G 5/00; G09G 3/28

(52) U.S. Cl. 345/1.3; 345/60

(57) ABSTRACT

A display device comprising a plurality of plasma tube array-type display sub-modules joined with a high precision is provided. The shapes of the display electrodes on the display electrode support sheets are identical in all of the plasma tube array-type display sub-modules joined. The plurality of plasma tube array-type display sub-modules are joined by a first connector joining the plasma tube array-type display sub-modules to one another, and a second connector connecting the plasma tube array-type display sub-modules to drive circuit substrates.

### CROSS-REFERENCE TO RELATED APPLICATIONS

This application claims priority to and the benefit of Japanese Application Ser. No. 2008-159763 which was filed Jun. 18, 2008, entitled Plasma Tube Array-Type Display Sub-Module and Display Device, the entirety of being hereby incorporated by reference as if fully set forth herein.

### BACKGROUND OF THE INVENTION

1. Field of the Invention

The present invention relates to a display device for a large screen wherein a plurality of plasma tube array-type display sub-modules is joined to one another. More particularly, the present invention relates to a display device comprising plasma tube array-type display modules wherein display electrodes of the plasma tube array-type display sub-modules are identical in shape.

2. Description of the Related Art

As a technology for realizing a next-generation large-screen display device, a plasma tube array-type display sub-module has been developed with a structure that a plurality of plasma tubes each filled with a discharge gas are arranged in parallel. For example, a large-screen display device having a scale of several meters by several meters in size can be constructed of a plasma tube array-type display system module that a plurality of plasma tube array-type display sub-modules of one meter square in size are joined to one another. The display device of such a type that the plurality of plasma tube array-type display sub-modules are joined to one another does not need either a large glass substrate to be handled, like an LCD, a PDP and the like, nor a large-scale facility and achieves uniform image quality at low cost. FIGS. 1A and 1B are schematic views of a large-scale display system module wherein three conventional plasma tube array-type display sub-modules are joined horizontally to one another.

FIG. 1A is a plan view showing schematically a large-scale display system module wherein three conventional plasma tube array-type display sub-modules are joined horizontally to one another. As shown in FIG. 1A, plasma tube array-type display sub-modules 1a, 1b and 1c respectively comprise display electrodes 10a, 10b and 10c formed according to a predetermined pattern on inner surfaces of flexible display electrode support sheets on the front side which are not shown, and address drive circuit substrates 11 connected to address electrodes formed on inner surfaces of flexible address electrode support sheets on the back side which are not shown (refer to JP 2004-178854 A).

FIG. 1B is a schematic view showing states of the display electrodes 10a, 10b and 10c. As shown in FIG. 1B, the display electrodes 10a, 10b and 10c are respectively constructed such that two display electrodes for an X electrode and a Y electrode form a pair in the plasma tube array-type display sub-modules 1a, 1b and 1c. In the plasma tube array-type display sub-module la provided on the left end of the plasma tube array-type display system module, display electrodes 15, 15, . . . , serving as the X electrodes and display electrodes 16, 16, . . . , serving as the Y electrodes are led out at the same position on the right end of the plasma tube array-type display sub-module 1a, while the X electrodes 15, 15, . . . are extended farther than the Y electrodes 16, 16, . . . toward the left side so that the protruding ends thereof is X electrode terminals on the left end. The X electrode terminals, which are thus protruding, are connected to an X-side drive circuit 12 through an X-side connector.

In the plasma tube array-type display sub-module 1c provided on the right end of the plasma tube array-type display system module, display electrodes 15, 15, . . . , serving as the X electrodes and display electrodes 16, 16, . . . , serving as the Y electrodes are led out to the same position on the left end of the plasma tube array-type display sub-module 1c, while the Y electrodes 16, 16, . . . are extended farther than the X electrodes 15, 15, . . . toward the right side so that protruding ends thereof is Y electrode terminals on the right end. The Y electrode terminals, which are thus protruding, are connected to a Y-side drive circuit 13 through a Y-side connector. In the plasma tube array-type display sub-module 1b provided in the middle of the plasma tube array-type display sub-modules 1a and 1c, display electrodes 15, 15, . . . , serving as the X electrodes and display electrodes 16, 16, . . . , serving as the Y electrodes are led out to the same position on the right and left sides.

As described above, in the conventional the plasma tube array-type display sub-modules, the three different display sub-modules 1a, 1b, 1c respectively comprising the display electrodes 10a, 10b 10c, with different layout patterns depending on where they are arranged, are prepared, and then connected by connectors 14, 14, . . . , so that a single plasma tube array-type display system module for a large screen is constructed. FIG. 1C is a schematic view showing a single display system module wherein the display electrodes 10a, 10b 10c of the three plasma tube array-type display sub-modules 1a, 1b, 1c are joined horizontally to one another.

The connectors 14, 14, . . . , for joining the plasma tube array-type display sub-modules 1a, 1b, 1c to one another connect the X electrodes and the Y electrodes of the display electrodes 10a, 10b, 10c bent toward the back side between the adjacent sub-modules together with a flexible electrode support sheet FF on the front side depending on a positional relationship between. FIGS. 2A and 2B are sectional views, orthogonal to the longitudinal direction of the plasma tubes 17, 17, . . . , showing configurations of the connectors 14 (14a, 14b) horizontally joining the conventional plasma tube array-type display sub-modules to one another. FIG. 2A is a sectional view in the case where the connector 14a is a dual contact connector, while FIG. 2B is a sectional view in the case where the connector 14b is a flexible cable connector.

In the configuration shown in FIG. 2A, on the ends of the adjacent plasma tube array-type display sub-modules, display electrodes 10, 10 supported on the inner surface of the flexible electrode support sheet FF on the front side are respectively bent toward the back side along end portions of plasma tubes 17, 17, . . . so that the display electrodes 10, 10 are placed in a back-to-back manner to the plasma tubes 17, 17, . . . with the electrode support sheet FF interposed there between, and the ends of the X and Y electrodes are interposed into the dual contact connector 14a and firmly held between the sides thereof. Moreover, conductive metal layer coated on the sub-module frames 19, 19 of the respective plasma tube array-type display sub-modules, which serve as ground electrodes, are connected to each other by a ground cable 20, so that a ground potential can be made equal to the respective plasma tube array-type display sub-modules. Also in the connection structure shown in FIG. 2B, the display electrodes 10, 10 of the adjacent plasma tube array-type display sub-modules are bent toward the back side along the outermost of the plasma tubes 17, 17, . . . . The ends of the bent display electrodes 10, 10 are interposed into input-side connection ports of relay connectors 14b, 14b together with the flexible electrode support sheet FF on the front side, and output-side connection ports of the relay connectors 14b, 14b are connected to each other by a flexible cable 21 having as many connection lines as the display electrodes 10, 10, . . . . Moreover, the sub-module frames 19, 19 serving as the ground electrodes are connected to each other by the ground cable 20 so that a ground potential can be made equal to the respective plasma tube array-type display sub-modules.

In the case where the plasma tube array-type display sub-modules 1a, 1b, 1c are joined horizontally to one another, thereby constructing a plasma tube array-type display system module for a large screen, however, there has been a following problem: it is necessary to distinctly distinguish the plasma tube array-type display sub-modules 1a, 1b, 1c from one another, if it is the plasma tube array-type display sub-module 1a to be connected to the X drive circuit 12, the plasma tube array-type display sub-module 1c to be connected to the Y drive circuit 13, or the plasma tube array-type display sub-module 1b in the middle to be connected to the adjacent right and left plasma tube array-type display sub-modules 1a, 1c; and the respective plasma tube array-type display sub-modules 1a, 1b, 1c can only be replaced with the same type of the plasma tube array-type display sub-modules in the case where some fault occur in any one of the plasma tube array-type display sub-modules 1a, 1b, 1c after constructing the plasma tube array-type display system module, which makes it difficult to reduce manufacturing costs.

In the case where the plasma tube array-type display sub-modules 1a, 1b, 1c are joined horizontally to one another, the position adjustment requires a high precision. If there is a large positional displacement between the adjacent plasma tube array-type display sub-modules 1a, 1b, 1c, an overload occurs on the display electrodes 10, 10 and the display electrodes 10, 10 are thereby possibly deformed. Thus, such a problem as disconnection may occur, which renders the display device malfunctioning. Moreover, in the case where assembling and disassembling processes are repeated such that the assembled plasma tube array-type display system module is disassembled into the plurality of plasma tube array-type display sub-modules 1a, 1b, 1c again, or the plurality of plasma tube array-type display sub-modules 1a, 1b, 1c are assembled into a single plasma tube array-type display system module again, the display electrodes 10, 10, . . . , may undergo an overload due to changes in the positions of the connectors 14, 14, . . . , and the resulting fluctuation of a tensile force of the cable connecting the display electrodes 10, 10, . . . , or the like, the deformation of the display electrodes 10, 10, . . . or the like, thereby caused may result in the disconnection.

### SUMMARY OF THE INVENTION

The present invention has been devised to solve the problems described above, and an object thereof is to provide a display device wherein a pattern of display electrodes is identical in all of plasma tube array-type display sub-modules and the plasma tube array-type display sub-modules are thereby joined horizontally to one another with a high precision.

In order to achieve the object, a first aspect of the present invention is directed to a display device comprising a plurality of plasma tube array-type display sub-modules joined to one another, each of which comprising a plurality of plasma tubes filled with a discharge gas, arranged in parallel, an address electrode support sheet having address electrodes formed along the longitudinal direction of the respective plasma tubes thereon, a display electrode support sheet having a plurality of first display electrodes and second display electrodes extending in the direction crossing all the plasma tubes thereon, and the plurality of plasma tubes held between the address electrode support sheet and the display electrode support sheet, wherein shapes of the first display electrode and the second display electrode on the display electrode support sheet are identical in all of the plasma tube array-type display sub-modules joined to one another, and the plurality of plasma tube array-type display sub-modules is joined to one another in a direction intersecting the plasma tubes by first connectors which connect between the first display electrodes, and between the second display electrodes, of the adjacent plasma tube array-type display sub-modules, and second connectors which connect the first display electrodes and the second display electrodes of the plasma tube array-type display sub-modules to drive circuit substrates.

According to the first aspect of the present invention, there is no need to alter the pattern of the display electrode pairs depending on the layout of the plasma tube array-type display sub-modules, and the display electrode pairs formed with the common pattern can be simply connected by the connectors selected depending on the layout thereof. Thus, the number of manufacturing steps can be largely reduced, and an inexpensive display device can be thereby provided. Another advantage is that the plasma tube array-type display sub-modules can be replaced with one another without any restrictions, which reduces the number of maintenance steps.

The “plasma tube array-type display sub-module” is a display film component comprising a plasma tube array as described earlier, and a semi-finished product of a display device which does not comprise a drive circuit, a power-supply circuit, and the like. The “plasma tube array-type display system module” is a system module wherein a plurality of plasma tube array-type display sub-modules are joined vertically and horizontally to one another by predetermined connectors, thereby constructing a single display panel, and a component constructing the display device by connecting a power supply circuit and the like thereto.

A second aspect of the present invention is directed to the display device according to the first aspect of the present invention, wherein the display electrode support sheets are arranged on the front side and bent toward the back side together with the first display electrodes and the second display electrodes between the adjacent plasma tube array-type display sub-modules and connected by the first connectors.

A third aspect of the present invention is directed to the display device according to the second aspect of the present invention, wherein the first connectors and the second connectors comprise the connection substrates each of which mounted on a back face of the respective display sub-modules and connected to the first display electrodes and the second display electrodes, and the first display electrodes and the second display electrodes of the adjacent plasma tube array-type display sub-modules are respectively connected through the connection substrates.

According to the third aspect of the present invention, the first connectors and the second connectors comprise the connection substrates connected to the first display electrodes and the second display electrodes, and the first display electrodes, the second display electrodes and ground electrodes are respectively connected with the connection substrates interposed there between, so that the display electrode pairs and the ground electrodes can be reliably spaced from each other so as to avoid the generation of electrical short circuit. Moreover, even in the case where the assembled plasma tube array-type display system module is disassembled into the plasma tube array-type display sub-modules again, or the plasma tube array-type display sub-modules are assembled into a single plasma tube array-type display system module again repeatedly, any overload is not generated in the display electrode pairs connected to the connection substrates of the connectors, and the deformation of the display electrode pairs due to the excess overload can be thereby prevented. Thus, a display device with a high quality, wherein the disconnection or the like is less likely to occur, can be provided.

A fourth aspect of the present invention is directed to the display device according to the third aspect of the present invention, wherein the connection substrate is mounted on the back face of the plasma tube array-type display sub-modules in the orthogonal direction to the back face thereof, and bonded to bending portions of the first display electrodes and the second display electrodes.

According to the fourth aspect of the present invention, the excess overload to the display electrode pairs due to the repeated cable connection and disconnection can be prevented, and the possibility of any contact failure due to troubles generated can be lessened. Thus, the connection can be unfailingly reliable.

A fifth aspect of the present invention is directed to the display device according to the third aspect of the present invention, wherein the connection substrate is mounted on the back face of the plasma tube array-type display sub-modules in the parallel direction to the back face thereof, and bonded to the bending portions of the first display electrodes and the second display electrodes.

According to the fifth aspect of the present invention, any overload possibly generated in the display electrode pairs when the cable connection is repeatedly provided and removed can be prevented, and the possibility of any contact failure resulting from troubles can be lessened. Thus, the connection can be unfailingly provided. Further, the connecting portion can be prevented from protruding toward the back side of the plasma tube array-type display sub-module. Thus, a display device wherein the flatness is improved can be provided.

In order to achieve the object, a sixth aspect of the present invention is directed to a plasma tube array-type display sub-module comprising a plurality of plasma tubes filled with a discharge gas, arranged in parallel, an address electrode support sheet having address electrodes formed along the longitudinal direction of the respective plasma tubes, and a display electrode support sheet having a plurality of first display electrodes and second display electrodes extending in the direction crossing all of the plasma tubes, and the plurality of plasma tubes held between the address electrode support sheet and a display electrode support sheet, wherein both ends of the first display electrodes and the second display electrodes alternately formed on the display electrode support sheets respectively terminate at the same position parallel to the plasma tubes arranged outermost.

According to the sixth aspect of the present invention, there is no need to alter the pattern of the display electrode pairs depending on the layout of the plasma tube array-type display sub-modules, and the display electrode pairs with the common pattern can be simply connected by the connectors selected depending on the layout thereof. Thus, the number of manufacturing steps can be largely reduced, and an inexpensive display device can be thereby provided. Another advantage is that the plasma tube array-type display sub-modules can be replaced with one another without any restrictions, which reduces the number of maintenance steps.

In order to achieve the object, a seventh aspect of the present invention is directed to a display device comprising the plurality of plasma tube array-type display sub-modules according to claim 9 joined to one another, wherein display electrode support sheets of the plasma tube array-type display sub-modules are formed on the front side, and adjacent end portions of the respective display electrode support sheets are bent toward the back side together with the first display electrodes and the second display electrodes and respectively connected to connectors mounted on a back face each of the adjacent plasma tube array-type display sub-modules, and the adjacent connectors are connected by a flexible cable.

According to the seventh aspect of the present invention, the excess overload to the display electrode pairs due to the repeated cable connection and disconnection can be prevented, and the possibility of any contact failure due to troubles generated can be lessened.

As described above, according to the present invention, there is no need to alter the pattern of the display electrode pairs depending on the layout of the plasma tube array-type display sub-modules, and the display electrode pairs with the common pattern can be simply connected by the connectors selected depending on the layout thereof. Thus, the number of manufacturing steps can be largely reduced, and a display device for a large screen, in which inexpensive plasma tube array-type display sub-modules are joined, can be thereby provided. Another advantage is that the plasma tube array-type display sub-modules can be replaced with one another without any restrictions, which reduces the number of maintenance steps.

### BRIEF DESCRIPTION OF THE DRAWINGS

FIGS. 1A and 1B are schematic views of a large-scale display system module wherein three conventional plasma tube array-type display sub-modules are joined horizontally to one another;

FIGS. 2A and 2B are sectional views, orthogonal to the longitudinal direction of plasma tubes showing configurations of connectors horizontally joining the conventional plasma tube array-type display sub-modules to one another;

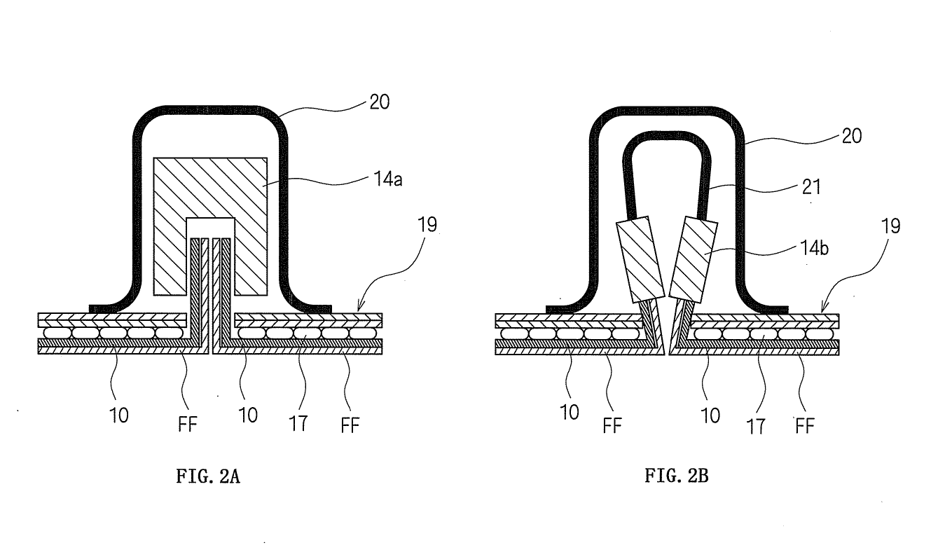

FIGS. 3A to 3C are perspective views schematically showing a configuration of a plasma tube array of a plasma tube array-type display sub-module used in a display device according to an embodiment of the present invention;

FIGS. 4A to 4C are schematic views briefly showing a configuration of a joining portion between the plasma tube array-type display sub-modules according to the embodiment of the present invention;

FIG. 5 is a sectional view, orthogonal to the longitudinal direction of the plasma tubes, showing a configuration wherein the plasma tube array-type display sub-modules according to the embodiment of the present invention are joined horizontally to one another;

FIGS. 6A and 6B are enlarged sectional views, orthogonal to the longitudinal direction of the plasma tubes, showing configurations in vicinity of connectors which horizontally connect the plasma tube array-type display sub-modules according to the embodiment of the present invention to one another;

FIG. 7 is a sectional view, orthogonal to the longitudinal direction of the plasma tubes, showing a configuration wherein the plasma tube array-type display sub-modules according to the embodiment of the present invention are joined horizontally to one another in the case where connection substrates are mounted substantially in parallel with the back face of the plasma tube array-type display sub-modules;

FIGS. 8A and 8B are enlarged sectional views, orthogonal to the longitudinal direction of the plasma tubes, showing configurations in vicinity of the connectors which horizontally connect the plasma tube array-type display sub-modules according to the embodiment of the present invention to one another in the case where the connection substrates are mounted substantially in parallel with the back face of the plasma tube array-type display sub-modules;

FIGS. 9A and 9B are enlarged schematic views focusing on the portion where display electrodes are connected; and

FIGS. 10A and 10B respectively illustrate examples of a plasma tube array-type display system module wherein a plurality of the plasma tube array-type display sub-modules according to the embodiment of the present invention is joined to one another.

### DESCRIPTION OF THE PREFERRED EMBODIMENTS

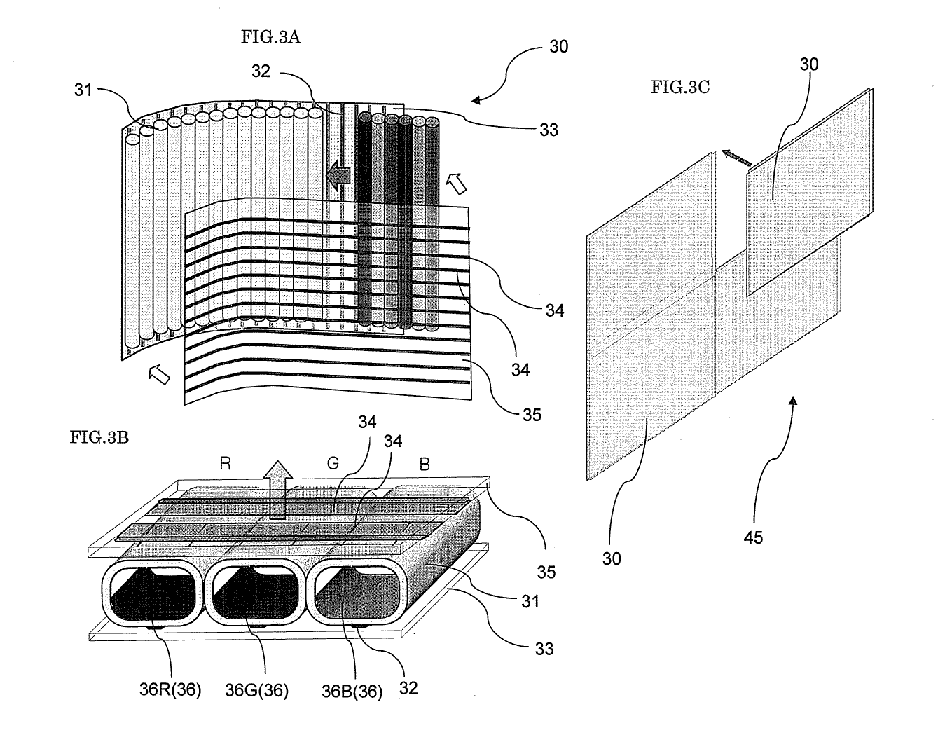

Hereinafter, a display device according to an embodiment of the present invention is described in detail referring to the drawings. FIGS. 3A to 3C are perspective views schematically showing a configuration of a plasma tube array of a plasma tube array-type display sub-module used in the display device according to the embodiment of the present invention. FIG. 3A is a perspective view schematically showing a configuration of a plasma tube array provided in the plasma tube array-type display sub-module. FIG. 3B is a perspective view showing a part of the configuration of the plasma tube array provided in the plasma tube array-type display sub-module. FIG. 3C is a perspective view showing a plasma tube array-type display system module, wherein the plasma tube array-type display sub-modules are joined vertically and horizontally to one another.

As shown in FIG. 3A, the plasma tube array-type display sub-module 30 according to this embodiment has a rectangular shape and a plurality of plasma tubes 31, 31, . . . each filled with a discharge gas is arranged in parallel. The plasma tube 31 is a discharging thin tube made of glass, whose diameter is not particularly limited, but desirably about 0.5 to 5 mm. Herein, for example, the plasma tube array-type display sub-module 30 of one square-meter is constructed in such a manner that 1000 pieces of glass thin tubes each having a diameter of 1 mm, a length of 1 m and an oblate ellipsoid section are arranged in parallel by a set of several pieces. The section of the thin tube is not particularly limited in shape, and examples thereof may include a circular section, an oblate ellipsoid section, a square section and the like. Moreover, the plasma tube 31 is filled with a discharge gas such as neon, xenon and the like at a predetermined ratio at a predetermined pressure.

The plurality of plasma tubes 31, 31, . . . arranged in parallel is held between a back-side address electrode support sheet 33, which comprises address electrodes 32, 32, . . . formed thereon so as to come into contact with the lower side in the longitudinal direction of the plasma tube 31, 31, . . . respectively, and a front-side (display-side) display electrode support sheet 35, which comprises display electrode pairs 34, 34, . . . formed thereon in the direction orthogonal to the longitudinal direction of the plasma tube 31, 31, . . . . Herein, the display electrode support sheet 35 is a flexible sheet made of, for example, a polycarbonate film, a PET (polyethylene terephthalate) film or the like.

The plurality of display electrode pairs 34, 34, . . . is formed in stripes on the inner surface of the display electrode support sheet 35 so as to come into contact with the plasma tubes 31, 31, . . . in the direction crossing the upper side of the plasma tubes 31, 31, . . . . The adjacent display electrodes 34, 34 form a display electrode pair and function as an X electrode and a Y electrode. Display discharge occurs inside the display tubes located between the X electrode and the Y electrode. In addition to the stripe pattern, the pattern of the display electrodes 34, 34, . . . may be a pattern which is publicly known in the relevant technical field, and examples thereof may include a mesh pattern, a ladder pattern, a comb pattern and the like. Moreover, the display electrode 34 can be formed by various materials which are publicly known in the relevant technical field. Examples of the materials for the display electrodes 34, 34 may include transparent conductive materials such as ITO (Indium Tin Oxide) and SnO₂, and metal conductive materials such as Ag, Au, Al, Cu and Cr and the like.

The display electrodes 34, 34 can be formed by various methods which are publicly known in the relevant technical field. For example, the display electrodes 34, 34 may be formed by using a thick film technology, such as a printing, or by using a thin film technology such as a physical deposition method or a chemical deposition method. Examples of the thick film technology may include a screen print method and the like. With regard to the thin film technology, examples of the physical deposition method may include an evaporation method, a sputtering method and the like whereas examples of the chemical deposition method may include a thermal CVD method, a photo-CVD method, a plasma CVD method and the like.

The address electrodes 32, 32, . . . is formed on the back side of the plasma tube array-type display sub-module 30 for each plasma tube 31 along the longitudinal direction of the plasma tube 31, 31, . . . wherein an emit light cell is formed at an intersection of the address electrode 32 and the paired display electrode 34. The address electrode 32 can be formed by various materials and methods which are publicly known in the relevant technical field.

In the configuration described above, as shown in FIG. 3B, the plasma tube array-type display sub-module 30 achieves color display in such a manner that each plasma tube 31 comprises a single-color phosphor layer 36. Examples of the phosphor layer 36 comprise a red (R) phosphor layer 36R, a green (G) phosphor layer 36G and a blue (B) phosphor layer 36B. A set of the plasma tube 31 comprising the R phosphor layer 36R, the plasma tube 31 comprising the G phosphor layer 36G and the plasma layer 31 comprising the B phosphor layer 36B forms one pixel, so that the plasma tube array-type display sub-module 30 can achieve color display. Herein, the R phosphor layer 36R is made of a phosphor material such as (Y,Gd)BO₃ :EU³⁺ in order to emit red light by irradiation with ultraviolet rays. The G phosphor layer 36G is made of a phosphor material such as Zn2 SiO₄:Mn in order to emit green light by irradiation with ultraviolet rays. The B phosphor layer 36B is made of a phosphor material such as BaMgAl₁₂O₁₇:Eu²⁺ in order to emit blue light by irradiation with ultraviolet rays. In order to enhance flexibility of the plasma tube array-type display sub-module 30 and facilitate the assembly thereof, preferably, a plasma tube unit is prepared in such a manner that the plurality of the set of the three plasma tubes for three colors R, G, B are attached to the reed-shaped back-side address electrode support sheet 33 in parallel, and then the plurality of plasma tube units is attached to the front-side display electrode support sheet 35, so that the plasma tube array-type display sub-module 30 for a color display is fabricated.

The perspective view in FIG. 3C schematically shows the plasma tube array-type display system module 45 wherein the plurality of plasma tube array-type display sub-modules 30, 30, . . . are joined vertically and horizontally to one another. As shown in FIG. 3C, herein, four pieces of plasma tube array-type display sub-modules 30, 30, . . . construct one plasma tube array-type display system module 45 for a large screen. Each plasma tube array-type display sub-module 30 is a semi-finished product which does not have a drive circuit, a power supply circuit and the like incorporated. After construction of the large-screen plasma tube array-type display system module 45, a drive circuit, a power supply circuit and the like are incorporated in the plasma tube array-type display system module 45 defining the whole system module as one display film. Thus, a large-screen display device can be constructed, which has a feature suppressing a variation in quality of images displayed on the respective plasma tube array-type display sub-modules 30, 30, . . . .

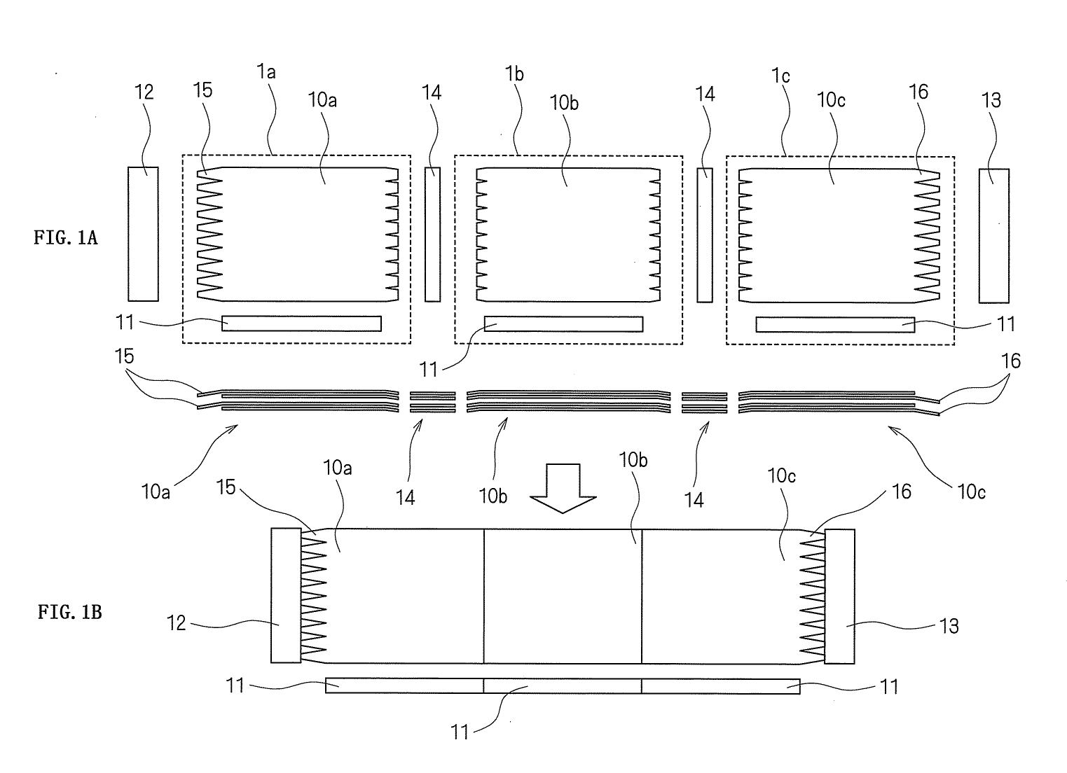

In case where the conventional plasma tube array-type display sub-modules are joined horizontally to one another, it is necessary to prepare three different types of the plasma tube array-type display sub-modules, as described above referring to FIG. 1A, which are the plasma tube array-type display sub-module provided with the display electrode 10a to be connected to the X drive circuit 12, the plasma tube array-type display sub-module provided with the display electrode 10b joining the adjacent plasma tube array-type display sub-modules, and the plasma tube array-type display sub-module provided with the display electrode 10c to be connected to the Y drive circuit 13.

However, if it is necessary to distinctly distinguish types of the plasma tube array-type display sub-modules from one another to decide where they should be arranged in order to construct the plasma tube array-type display system module 45 for a large screen, a working efficiency is deteriorated. Further, if any of the plasma tube array-type display sub-modules undergoes failure, it can only be replaced with the exactly same type of the plasma tube array-type display sub-module which inconveniently does not allow the plasma tube array-type display sub-modules to be free to replace with one another.

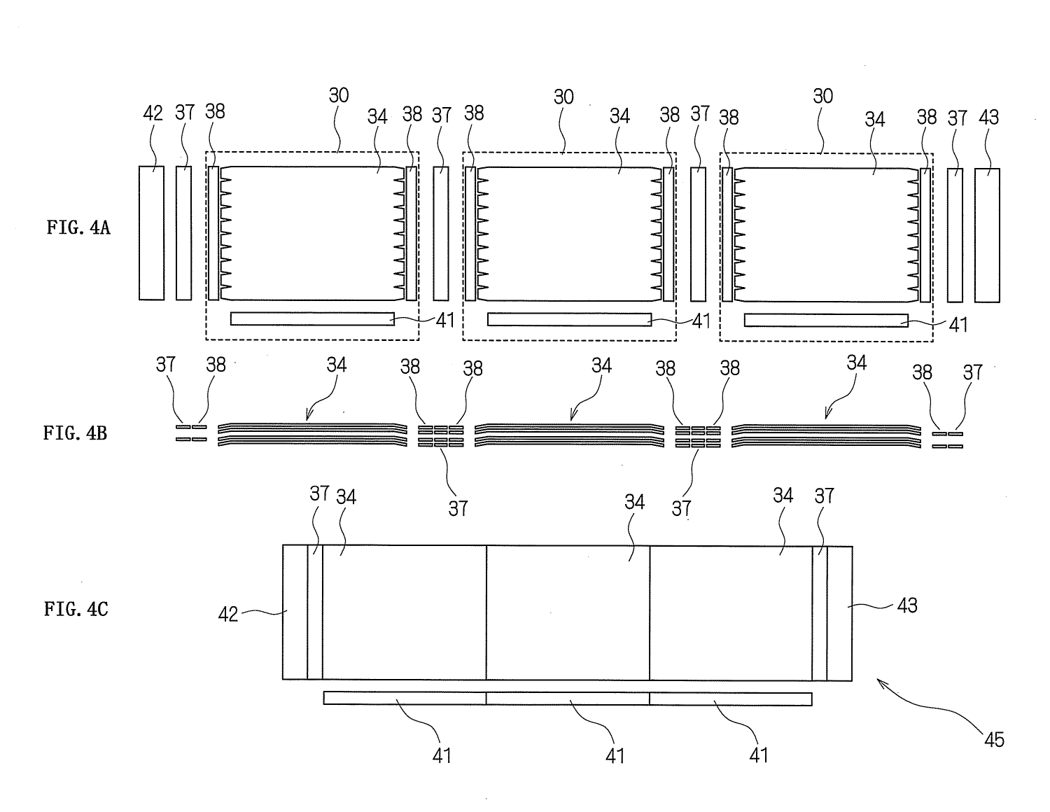

According to the present invention, therefore, the layout pattern of the display electrodes 34, 34, . . . of the plasma tube array-type display sub-modules 30, 30, . . . , are identical, so that a cable wiring can be effectively used to join the plasma tube array-type display sub-modules 30, 30, . . . by connectors separately provided depending on which of the X drive circuit, another plasma tube array-type display sub-module 30 or the Y drive circuit should be connected. FIGS. 4A to 4C are schematic views briefly showing a configuration of a joining portion between the plasma tube array-type display sub-modules according to the embodiment of the present invention.

FIG. 4A is a plan view briefly showing the joining of the plasma tube array-type display sub-modules 30, 30, . . . in parallel. As shown in FIG. 4A, the plasma tube array-type display sub-modules 30, 30 and 30 respectively are provided with the display electrodes 34, 34 and 34 formed with a common electrode pattern, and an address drive circuit substrate 41.

FIG. 4B is a schematic view showing how the display electrodes 34, 34 and 34 are formed. As shown in FIG. 4B, the display electrodes 34, 34 and 34 wherein two display electrodes for an X electrode and a Y electrode form a pair, are formed so as to have the same length and the common electrode pattern in all of the plasma tube array-type display sub-module 30 to be connected to an X drive circuit 42, the plasma tube array-type display sub-module 30 to be connected to a Y drive circuit 43, and the plasma tube array-type display sub-module 30 to be joined to the other plasma tube array-type display sub-modules 30, 30. More specifically, both ends of the plurality of display electrodes 34, 34 and 34 respectively terminate at the same position substantially in parallel with the plasma tubes of the plasma tube array-type display sub-modules 30, 30 and 30 arranged outermost.

As described above, the plasma tube array-type display sub-modules 30, 30 and 30 respectively provided with the display electrodes 34, 34 and 34 with the same length and the common electrode pattern are joined to one another by connectors 38, 38, . . . and by cables 37, 37, . . . which connect the connectors 38, 38, . . . selected depending on the position where the plasma tube array-type display sub-modules 30, 30 and 30 are provided. Thus, a single plasma tube array-type display system module 45 for a large screen can be constructed (see FIG. 4B).

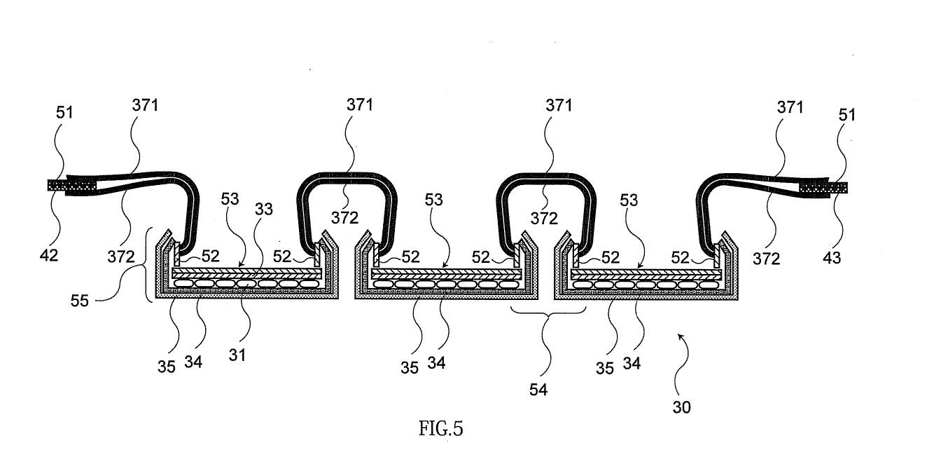

The connectors 38, 38, . . . connect the display electrodes 34, 34 and 34 bent toward the back side so as to prevent them from electrically short-circuiting to a ground electrode or the like. FIG. 5 is a sectional view, orthogonal to the longitudinal direction of the plasma tubes 31, 31, . . . , showing a configuration wherein the plasma tube array-type display sub-modules according to the embodiment of the present invention are joined horizontally to one another.

As shown in FIG. 5, the display electrode support sheet 35 having the plurality of display electrodes 34, 34, . . . is bent toward the back side along the end portions of the plasma tube array-type display sub-modules 30, 30, . . . comprising the plurality of plasma tubes 31, 31, . . . , and then pressure-bonded to a connection substrate 52. The connection substrates 52, 52 comprised in the connectors 38, 38 is respectively mounted on a back face of the display sub-modules. And then, adjacent connection substrates can be connected such that the cable 37 (composed of a pair of a ground cable 371 and a connection cable 372) can be prevented from electrically short-circuiting, and the connection substrates 52, 52 are connected to each other, or the connection substrate 52 and the X drive circuit 42 or the Y drive circuit 43 are connected to each other.

Ground conductors 51 are provided on the back side of the X drive circuit board 42 and the Y drive circuit board 43. Further ground conductors 53 are provided in the form of a metal films coated on the hard plastic sub-module frame of the respective plasma tube array-type display sub-modules 30, 30, . . . . All of the ground conductors are commonly connected so that a ground potential can be made equal to all of the plasma tube array-type display sub-modules 30, 30, . . . , joined to one another. In FIG. 5, the bent display electrode support sheets 35, 35 comprising a pair of the connection substrates 52, 52 which connect the plasma tube array-type display sub-modules 30, 30 to one another, and the like, are defined as a “first connector” 54, while the bent display electrode support sheets 35, 35 comprising the connection substrates 52, 52 which connect the plasma tube array-type display sub-module 30 to the X drive circuit 42 or the Y drive circuit 43, and the like, are defined as a “second connector” 55.

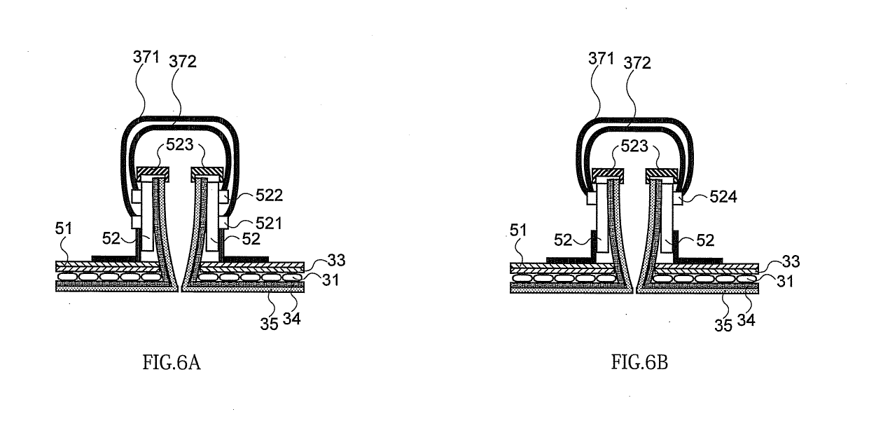

FIGS. 6A and 6B are enlarged sectional views, orthogonal to the longitudinal direction of the plasma tubes 31, 31, . . . , showing configurations in vicinity of the connectors 38, 38, . . . which horizontally connect the plasma tube array-type display sub-modules 30, 30, . . . according to the embodiment of the present invention to one another. FIG. 6A shows the case where a ground terminal and an electrode terminal are provided on the connection substrate 52, while FIG. 6B shows the case where a dual-contact terminal is provided on the connection substrate 52.

In FIG. 6A, the display electrode support sheet 35 having the display electrodes 34, 34, . . . is bent toward the back side along the outermost plasma tube or end portions of the plasma tube array-type display sub-modules 30, 30, . . . comprising of the plurality of plasma tubes 31, 31, . . . , and then pressure-bonded to the connection substrate 52. The connection substrate 52 is mounted with a ground terminal 521 and an electrode terminal 522 so that the connection substrates 52, 52 are connected to each other such that the ground cable 371 and the connection cable 372 are prevented from electrically short-circuiting between the connection substrates 52, 52. The ground terminals 521, 521 are connected to each other by the ground cable 371, while the electrode terminals 522, 522 are connected to each other by the connection cable 372. Accordingly, these cables 371, 372 are not electrically short-circuited to each other. Moreover, the connection substrate 52 and the display electrode support sheet 35 are fixed to each other by a clamp 523, so that the connection substrate 52 can be firmly secured.

In FIG. 6B, the display electrode support sheet 35 having the display electrodes 34, 34, . . . is bent toward the back side along the end portions of the plasma tube array-type display sub-modules 30, 30, . . . comprising the plurality of plasma tubes 31, 31, . . . , and then pressure-bonded to the connection substrate 52. The connection substrate 52 is mounted with the dual-contact terminal 524 so that the connection substrates 52, 52 are connected to each other such that the ground cable 371 and the connection cable 372 can be prevented from electrically short-circuiting. The dual-contact terminals 524, 524 are connected to each other by the ground cable 371, and the dual-contact terminals 524, 524 are connected to each other by the connection cable 372. Accordingly, these cables 371, 372 are not electrically short-circuited to each other. In the case where the ground cable 371 and the connection cable 372 are integrated to have a double-layer structure, the short circuit can be more reliably prevented. Moreover, the connection substrate 52 and the display electrode support sheet 35 are fixed to each other by the clamp 523, so that the connection substrate 52 can be firmly secured.

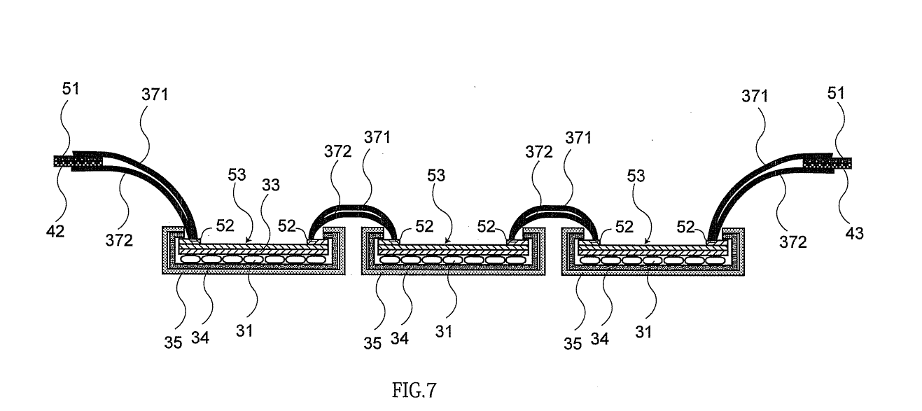

In FIGS. 5 and 6, the connection substrate 52 is mounted in such a direction substantially orthogonal to the back face of the plasma tube array-type display sub-modules 30, 30, . . . , however, the connection substrate 52 is not necessarily thus configured. The connection substrate 52 may be mounted in such a direction substantially in parallel with the back face of the plasma tube array-type display sub-modules 30, 30, . . . . FIG. 7 is a sectional view, orthogonal to the longitudinal direction of the plasma tubes 31, 31, . . . , showing a configuration wherein the plasma tube array-type display sub-modules 30, 30, and 30, according to the embodiment of the present invention are joined horizontally to one another in the case where the connection substrates 52, 52 . . . are mounted substantially in parallel with the back face of the plasma tube array-type display sub-modules 30, 30, . . . .

As shown in FIG. 7. the display electrode support sheet 35 having the display electrodes 34, 34, . . . is bent toward the back side along the outermost plasma tube or end portions of the plasma tube array-type display sub-modules 30, 30, . . . comprising the plurality of plasma tubes 31, 31, . . . , and then pressure-bonded to the connection substrate 52. The connection substrate 52 is mounted substantially in parallel with the back face of the plasma tube array-type display sub-modules 30, 30, . . . . The connection substrates 52, 52 can be connected to each other in such a manner that the ground cable 371 and the connection cable 372 are not short-circuited, and the connection substrates 52, 52 are connected to each other, or the connection substrate 52 and the X drive circuit 42 or the Y drive circuit 43 are connected to each other.

The ground conductors 51, 53 are provided on the back side of the X drive circuit board 42 or the Y drive circuit board 43 and the back face of the sub-module frame each of the plasma tube array-type display sub-module 30 so that the ground potential can be made equal to all of the plasma tube array-type display sub-modules 30, 30, . . . , joined to one another.

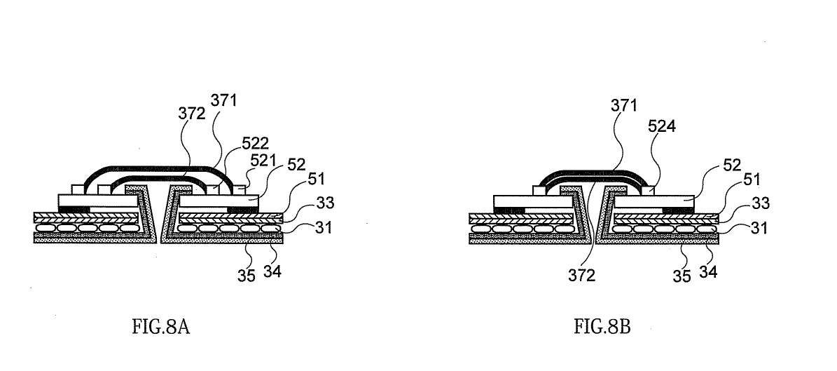

FIGS. 8A and 8B are enlarged sectional views, orthogonal to the longitudinal direction of the plasma tubes 31, 31, . . . , showing configurations in vicinity of the connectors 38, 38, . . . which horizontally connect the plasma tube array-type display sub-modules 30, 30, . . . , according to the embodiment of the present invention to one another in the case where the connection substrates 52, 52, . . . are mounted substantially in parallel with the back face of the plasma tube array-type display sub-modules 30, 30, . . . . FIG. 8A shows the case where the ground terminal and the electrode terminal are provided on the connection substrate 52, while FIG. 8B shows the case where the dual-contact terminal is provided on the connection substrate 52.

In FIG. 8A, the display electrode support sheet 35 having the display electrodes 34, 34, . . . is bent toward the back side along the end portions of the plasma tube array-type display sub-modules 30, 30, . . . comprising the plurality of plasma tubes 31, 31, . . . , and then pressure-bonded to the connection substrate 52. The connection substrates 52, 52, . . . are mounted substantially in parallel with the back face of the plasma tube array-type display sub-modules 30, 30, . . . . One end portion of the connection substrate 52 and the display electrode 34 of the display electrode support sheet 35 are thermally pressure-bonded and thereby connected to each other.

The connection substrates 52, 52 are respectively mounted with the ground terminal 521 and the electrode terminal 522 so that the connection substrates 52, 52 are connected to each other in such a manner that the ground cable 371 and the connection cable 372 are not short-circuited. The ground terminals 521, 521 are connected to each other by the ground cable 371, while the electrode terminals 522, 522 are connected to each other by the connection cable 372. Accordingly, these cables 371, 372 are not electrically short-circuited to each other.

In FIG. 8B same as in FIG. 8A, the display electrode support sheet 35 having the display electrodes 34, 34, . . . is bent toward the back side along the end portions of the plasma tube array-type display sub-modules 30, 30, . . . comprising the plurality of plasma tubes 31, 31, . . . , and then pressure-bonded to the connection substrate 52. The connection substrate 52 is mounted substantially in parallel with the back face of the plasma tube array-type display sub-modules 30, 30, . . . . One end portion of the connection substrate 52 and the display electrode 34 of the display electrode support sheet 35 are thermally pressure-bonded and thereby connected to each other.

The connection substrate 52 is mounted with the dual-contact terminal 524 so that the connection substrates 52, 52 are connected to each other such that the ground cable 371 and the connection cable 372 can be prevented from electrically short-circuiting. The dual-contact terminals 524, 524 are connected to each other by the ground cable 371, and the dual-contact terminals 524, 524 are connected to each other by the connection cable 372. Accordingly these cables 371, 372 are not electrically short circuited to each other. In the case where the ground cable 371 and the connection cable 372 are integrated to have a double-layer structure, the short circuit can be more reliably prevented.

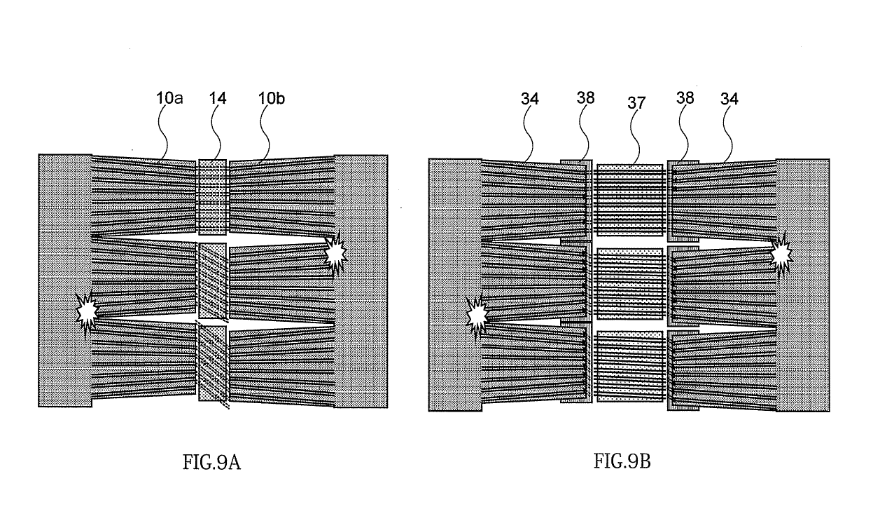

When the plurality of the plasma tube array-type display sub-modules 30, 30, . . . , wherein the display electrodes 34, 34, . . . have the common electrode pattern, are joined to one another by the connectors 38, 38, . . . and the cables 37, 37, . . . comprising the connection substrates 52, 52, . . . the overload, which was conventionally imposed on the display electrodes every time upon setting and disassembling, can be reduced. FIGS. 9A and 9B are enlarged schematic views focusing on the portion where the display electrodes 34, 34 are connected. FIG. 9A is an enlarged schematic view of conventional joining portion there between for comparison, while FIG. 9B is an enlarged schematic view of joining portion according to the embodiment of the present invention.

As shown in FIG. 9A, the display electrodes 10a and 10b of the adjacent display sub-modules were conventionally connected by the connectors 14. Therefore, the display electrodes 10a and 10b may be overloaded in the connecting process, or may be similarly overloaded in the disassembling process. Accordingly, the display electrodes 10a and 10b per se were possibly damaged due to a bending load, a tensile load or the like overly applied thereto.

As shown in 9B, according to this embodiment, wherein the display electrodes 34, 34, . . . are respectively connected to the connectors 38, 38, . . . mounted on the back face, a relative positional relationship between the connectors 38, 38, . . . , and the display electrodes 34, 34, . . . , remain unchanged once the display electrodes 34, 34, . . . , are connected to the connectors 38, 38, . . . , even if the connection and the disconnection are repeated because they are connected and disconnected through the cables 37. Therefore, as far as the setting is once completed so that any overload is not applied to the display electrodes 34, 34, . . . , upon the first setting, neither of the bending load nor the tensile load or the like is thereafter overly applied to the display electrodes 34, 34, . . . , even if the connection and the disconnection are repeated, and any possible damage to the display electrodes 34, 34, . . . , can be prevented.

As described above, according to the present embodiment, the display electrodes 34, 34, . . . , on the display electrode support sheets 35, 35, . . . , in all of the plasma tube array-type display sub-modules 30, 30, . . . , have an identical shape. Therefore, the plurality of plasma tube array-type display sub-modules 30, 30, . . . , can be joined vertically and horizontally to one another by the first connectors 54, 54, . . . which connect the plasma tube array-type display sub-modules 30, 30 to one another, and the second connectors 55, 55, . . . which connect the plasma tube array-type display sub-module 30 to the X drive circuit 42 or the Y drive circuit 43. Accordingly, it does not need to alter the common pattern of the display electrodes 34, 34, . . . , depending on the layout of the plasma tube array-type display sub-modules 30, 30, . . . , and the display electrodes 34, 34 each formed with the common pattern can be simply connected by the connectors selected depending on the position where the plasma tube array-type display sub-modules 30, 30, . . . are provided. Thus, the number of manufacturing steps can be reduced, and the plasma tube array-type display sub-module 30, 30, . . . can be inexpensively provided. Moreover, the plasma tube array-type display sub-modules 30, 30, . . . can be replaced with one another without any restrictions, which can reduce the number of maintenance steps.

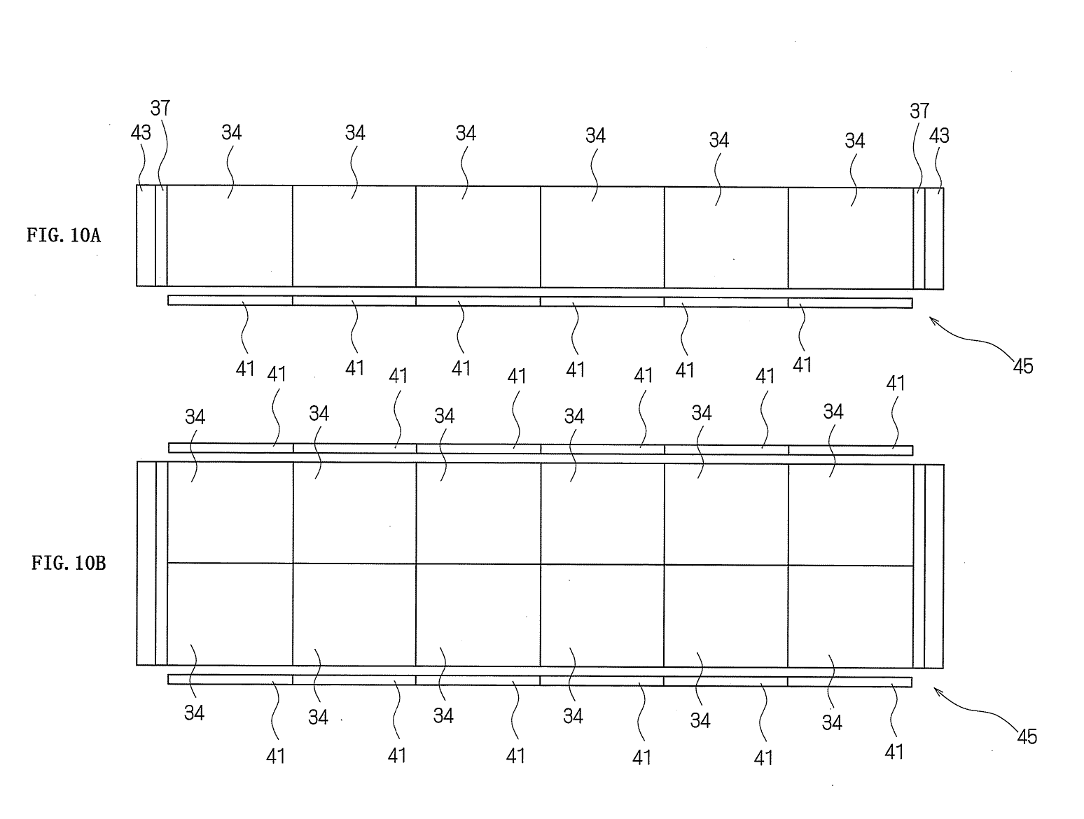

FIGS. 10A and 10B respectively illustrate examples of the plasma tube array-type display system module 45 wherein the plurality of plasma tube array-type display sub-modules 30, 30, . . . according to the embodiment of the present invention is joined to one another. FIG. 10A illustrates an example of the plasma tube array-type display system module 45 wherein the plasma tube array-type display sub-modules 30, 30, . . . are joined horizontally to one another in a single row, while FIG. 10B illustrates an example of the plasma tube array-type display system module 45 wherein the plasma tube array-type display sub-modules 30, 30, . . . are joined vertically and horizontally to one another.

As shown in FIG. 10A, in the case where the plurality of plasma tube array-type display sub-modules 30, 30, . . . , are joined horizontally to one another in a single row, there hardly appears any gap between the plasma tube array-type display sub-modules 30, 30, . . . , and the display electrodes 34, 34 are virtually continuously provided.

As shown in FIG. 10B, in the case where the plurality of plasma tube array-type display sub-modules 30, 30, . . . , are joined vertically and horizontally to one another, there hardly appears any gap between the plasma tube array-type display sub-modules 30, 30 and the display electrodes 34, 34 are virtually continuously provided.

As shown in FIG. 10B, the six plasma tube array-type display sub-modules 30, 30, . . . , on the upper side and the six plasma tube array-type display sub-modules 30, 30, . . . , on the lower side may be different. In the case where the six plasma tube array-type display sub-modules 30, 30, . . . , on the lower side are used as the six plasma tube array-type display sub-modules 30, 30, . . . , on the upper side, they are rotated 180 degrees in view of the positional relationship between the address drive circuit substrates and then provided. Accordingly, in the case where three primary colors in the plasma tube arrays of the plasma tube array-type display sub-modules 30, 30, . . . , on the lower side are arranged in such an order as R, G and B, the three primary colors in the plasma tube arrays of the plasma tube array-type display sub-modules 30, 30, . . . , on the upper side will be arranged in the opposite order as B, G and R. Therefore, it is necessary to prepare the plasma tube array-type display sub-modules 30, 30, . . . , for both the lower side and the upper side, wherein the order of the three primary colors in the respective plasma tube arrays thereof is reversed, so that the three primary colors arranged in the same order on both the lower side and the upper side. However, the desirable effect described above can be obtained as far as the common electrode pattern is adopted in the plasma tube array in the plasma tube array-type display sub-modules 30, 30, . . . , joined horizontally to one another.

There is no limit to the number of the plasma tube array-type display sub-modules 30, 30, . . . , which are joined vertically and horizontally to one another, and variously increased or decreased depending on a demanded screen size. Needless to say, various modifications, replacements and the like can be made within the originally intended scope of the present invention.

What is claimed is:

1. A display device comprising:
a plurality of plasma tube array-type display sub-modules joined to one another, each of which comprising:
a plurality of plasma tubes filled with a discharge gas, arranged in parallel;
an address electrode support sheet having address electrodes formed along the longitudinal direction of the respective plasma tubes thereon;
a display electrode support sheet having a plurality of first display electrodes and second display electrodes extending in the direction crossing all the plasma tubes thereon; and
the plurality of plasma tubes held between the address electrode support sheet and the display electrode support sheet, wherein
shapes of the first display electrode and the second display electrode on the display electrode support sheet are identical in all of the plasma tube array-type display sub-modules joined to one another, and
the plurality of plasma tube array-type display sub-modules is joined to one another in a direction intersecting the plasma tubes by first connectors which connect between the first display electrodes, and between the second display electrodes, of the adjacent plasma tube array-type display sub-modules, and second connectors which connect the first display electrodes and the second display electrodes of the plasma tube array-type display sub-modules to drive circuit substrates.

2. The display device according to claim 1, wherein
the display electrode support sheets are arranged on the front side and bent toward the back side together with the first display electrodes and the second display electrodes between the adjacent plasma tube array-type display sub-modules and connected by the first connectors.

3. The display device according to claim 2, wherein
the first connectors and the second connectors comprise the connection substrates each of which mounted on a back face of the respective display sub-modules and connected to the first display electrodes and the second display electrodes, and
the first display electrodes and the second display electrodes of the adjacent plasma tube array-type display sub-modules are respectively connected through the connection substrates.

4. The display device according to claim 2, wherein
the first connectors and the second connectors comprise the connection substrates each of which mounted on a back face of the respective display sub-modules and connected to the first display electrodes and the second display electrodes, and
the first display electrodes, the second display electrodes and ground electrodes of the adjacent plasma tube array-type display sub-modules are respectively connected through the connection substrates.

5. The display device according to claim 3, wherein
the connection substrate is mounted on the back face of the plasma tube array-type display sub-modules in-the orthogonal direction to the back face thereof, and bonded to bending portions of the first display electrodes and the second display electrodes.

6. The display device according to claim 4, wherein
the connection substrate is mounted on the back face of the plasma tube array-type display sub-modules in the orthogonal direction to the back face thereof, and bonded to bending portions of the first display electrodes and the second display electrodes.

7. The display device according to claim 3, wherein
the connection substrate is mounted on the back face of the plasma tube array-type display sub-modules in the parallel direction to the back face thereof, and bonded to bending portions of the first display electrodes and the second display electrodes.

8. The display device according to claim 4, wherein
the connection substrate is mounted on the back face of the plasma tube array-type display sub-modules in the parallel direction to the back face thereof, and bonded to bending portions of the first display electrodes and the second display electrodes.

9. A plasma tube array-type display sub-module comprising:
a plurality of plasma tubes filled with a discharge gas, arranged in parallel;
an address electrode support sheet having address electrodes formed along the longitudinal direction of the respective plasma tubes;
and a display electrode support sheet having a plurality of first display electrodes and second display electrodes extending in the direction crossing all of the plasma tubes; and
the plurality of plasma tubes held between the address electrode support sheet and a display electrode support sheet, wherein
both ends of the first display electrodes and the second display electrodes alternately formed on the display electrode support sheets respectively terminate at the same position parallel to the plasma tubes arranged outermost.

10. A display device comprising:
the plurality of plasma tube array-type display sub-modules according to claim 9 joined to one another, wherein
display electrode support sheets of the plasma tube array-type display sub-modules are formed on the front side, and
adjacent end portions of the respective display electrode support sheets are bent toward the back side together with the first display electrodes and the second display electrodes and respectively connected to connectors mounted on a back face each of the adjacent plasma tube array-type display sub-modules, and the adjacent connectors are connected by a flexible cable.
